(19) United States
(12) Patent Application Publication
(10) Pub. No.: US 2026/0084907 A1
(43) Pub. Date: Mar. 26, 2026

(54) Goods Transport System, Control Unit, Construction Kit, Simulation Program Product, and Use of an Active Component of a Planar Motor

(71) Applicant: Siemens Aktiengesellschaft, Muenchen (DE)

(72) Inventors: Martin STREUBÜHR, Zirndorf (DE); Philipp KUNZE, Nürnberg (DE); Christian CRAMER, Burgthann-Ezelsdorf (DE)

(21) Appl. No.: 19/106,910

(22) PCT Filed: Jul. 26, 2023
(86) PCT No.: PCT/EP2023/070743

§ 371 Date: Feb. 26, 2025

(30) Foreign Application Priority Data
Aug. 30, 2022 (EP) 22192908.6

(51) Int. Cl. B65G 54/02

(52) U.S. Cl. CPC B65G 54/02; B65G 2203/0225; B65G 2203/0233; B65G 2203/041

(57) ABSTRACT

A control unit for operating a goods transport system, a construction kit for producing the goods transport system, and a simulation program product for adjusting the operational behavior of the goods transport system, wherein the goods transport system includes a feed rail and a discharge rail that are each configured as a linear motor, where the rails are configured to linearly move a workpiece support, where a deflecting module is arranged between the feed rail and the discharge rail is configured to move the workpiece support in a specifiable manner, where the deflecting module is further configured as an active component of a planar motor.

### CROSS-REFERENCE TO RELATED APPLICATIONS

This is a U.S. national stage of application No. PCT/EP2023/070743 filed 26 Jul. 2023. Priority is claimed on European Application No. 22192908.6 filed 30 Aug. 2022, the content of which is incorporated herein by reference in its entirety.

### BACKGROUND OF THE INVENTION

### 1. Field of the Invention

The invention relates to a goods transport system, a control unit, a construction kit configured for constructing the goods transport system, and a simulation program product that is configured to simulate the operational behavior of the goods transport system.

### 2. Description of the Related Art

International application WO 2022/063848 A1 discloses an electromagnetic transport system that includes a plurality of transport units that can be moved along transport routes via drive coils. The transport routes can be provided with longitudinal stator linear motors, planar motors or combinations thereof.

US. Pub. No. 2021/0336522 A1 discloses a transport system that comprises a plurality of planar motors on which goods can be moved on flat transport sliders. The transport sliders are controllable via the planar motors such that their movement direction can be changed.

Goods transport systems are utilized in a large number of automation installations, in particular, production installations or logistics systems. There is a need for an increasing transport capacity, in particular, in the form of an enhanced throughput speed of the goods transport system. At the same time, increasing demands are being placed upon versatility to operate different transport routes within the goods transport system. Simultaneously, increased economic efficiency is required.

### SUMMARY OF THE INVENTION

In view of the foregoing, it is therefore an object of the invention to provide a capability which offers an improvement in at least one of the aspects outlined.

This and other objects and advantages are achieved in accordance with the invention by a goods transport system that can be used in an automation installation, for example, a production installation or a logistics system. The goods transport system comprises at least one feed rail and one discharge rail, each of which is configured as a linear motor. A workpiece carrier can be moved in a specifiable manner on the feed rail. The movement of the workpiece carrier is herein substantially a contactless sliding via electromagnetic fields. In an intended operation of the goods transport system, the workpiece carrier, which serves to transport a transport good, can be moved in a linear manner with a specifiable direction, speed and acceleration. Similarly, the feed rail serves to move the workpiece carrier linearly in a specifiable manner. In the context of the goods transport system in accordance with the invention, the feed rail serves for feeding the workpiece carrier and the discharge rail serves for discharging the workpiece carrier on which the transport goods can be transported.

The goods transport system has a deflecting module that is arranged between the feed rail and the discharge rail. The deflecting module is configured such that the workpiece carrier crosses the deflecting module on the route from the feed rail to the discharge rail. The deflecting module is configured to act upon a movement of the workpiece carrier. In accordance with the invention, for this purpose, the deflecting module is configured as an active component of a planar motor. The deflecting module is provided with actuatable electromagnetic components, in particular, electromagnets that are configured to act upon the workpiece carrier. As a consequence, the workpiece carrier can be moved along and transversely to a direction defined by the feed rail. The direction defined by the feed rail and/or the transport rail is therein to be understood as the main transport direction.

During the operation of the goods transport system in accordance with the invention, the deflecting module can be used as a switch, via which the workpiece carrier can be deflected onto a discharge rail that can be oriented substantially arbitrarily. This makes it possible, for example, to deflect the workpiece carrier with a reduced radius of curvature. Similarly, geometrically more complex deflections of the workpiece carrier are possible. The goods transport system in accordance with the invention thereby enables complex automation installations to be compactly constructed. At the same time, through the use of linear motors as the feed rail and the discharge rail, a higher transport speed can be achieved, i.e., an increased throughput speed in the goods transport system. The use of complex manipulators, for example, robot arms for deflecting workpiece carriers and/or transport goods on other goods transport systems is also dispensable. In this way, the goods transport system in accordance with the invention is cost-effective and is also suitable for transport goods that are subject to damage when handled by manipulators. Linear motors and planar motors have a reduced number of moving parts and thereby offer an enhanced level of robustness against wear. The goods transport system in accordance with the invention thus also has an increased level of reliability.

In accordance with the invention, with the deflecting module, the workpiece carrier can be rotated about a rotation axis in a specifiable manner. The rotation axis is therein arranged substantially perpendicularly to the main plane of the deflecting module which crosses the workpiece carrier during the intended operation. The rotation direction is herein specifiable by a corresponding actuation of the deflecting module, i.e., the active component. With this, the workpiece carrier can be passed on, by adapting its orientation, from the feed rail to the discharge rail. In particular, the workpiece carrier can be brought on the deflecting module into an orientation that enables a simplified merging in on the discharge rail. With this, in an automation installation in which the goods transport system is utilized, further handling operations are dispensable or are at least simplified.

In accordance with the invention, the feed rail and/or the discharge rail are also provided with mechanical guiding elements, via which a demerging and/or a merging in of the workpiece carrier is supported. In this way, a deflection of the workpiece carrier can be further supported.

In one embodiment of the goods transport system, the linear motor, which is utilized, for example, as a feed rail and/or a discharge rail, can be configured only for a linear movement of the workpiece. The workpiece is consequently movable only one-dimensionally on the feed rail and/or the discharge rail. Such linear motors are simpler and more cost-efficient than planar motors, which permit an at least two-dimensional movement of the workpiece carrier, in particular a movement along second translational axes. The use of complex and costly planar motors in the claimed goods transport system is therefore reduced.

Similarly, the deflecting module can be configured, at least in a central region, in a manner free from mechanical guiding elements. The central region of the deflecting module can herein be a region in which, during an intended operation, the deflection of the workpiece carrier occurs. The central region can be, in particular, a region on the deflecting module in which possible paths of the workpiece carrier cross each other and/or branch from one another. The deflection of the workpiece carrier can thus be specified via control commands that can be output by a control unit of the goods transport system. The deflecting module is configured to be free of guiding elements, at least in the central region. As a result, the degrees of freedom that the workpiece carrier has on the deflecting module can be more effectively used. The technical potential of the deflecting module is thereby utilized in an appropriate manner. Optionally, the deflecting module can be provided, in at least one edge region, with a mechanical guiding element, for example, in order to prevent a workpiece carrier leaving the deflecting module and thus the goods transport system. Further alternatively, the deflecting module can be configured free from mechanical guiding elements.

In another embodiment of the goods transport system, the workpiece carrier can be provided with at least one passive component of a planar motor. A passive component should be understood herein to be a counterpart to the active component, which cannot be actuated directly and has only passive components. The workpiece carrier can be provided with a single passive component, whereby it can be actuated in a simple manner. In particular, an acquisition of a position and/or orientation of the workpiece is simplified. Alternatively, the workpiece carrier can be provided with a plurality of passive components. The passive components can be arranged spaced from a center of gravity of the workpiece carrier, the transport goods or a combined center of gravity of the workpiece carrier and of the transport good. The resulting increased lever lengths permit an accelerated rotation of the workpiece carrier. A loss of speed and thus a loss of time on the deflecting module is can thereby be reduced. This permits the speed of the workpiece carrier that is achievable on the feed rail to be utilized more effectively.

In a further embodiment of the goods transport system, the feed rail and the discharge rail can be arranged offset from one another with respect to their transport main axes. Accordingly, given a straight-line further movement along the transport main axis of the feed rail, the workpiece carrier misses the discharge rail. As a result, the deflecting module is configured to displace a path of the workpiece carrier parallel to its main plane, i.e., for example, in a curved or S-shaped manner. The feed rail and the discharge rail can have substantially any desired orientation to one another. The inventive goods transport system is thus adaptable to an existing automation installation and can be retrofitted in the process of a reconfiguration or an upgrade. In particular, the versatility of an existing automation installation can be increased via the inventive goods transport system.

Furthermore, the active component of the planar motor can have a pole pair width that corresponds substantially to the pole pair width of a linear motor, i.e., for example, of the feed rail and/or of the discharge rail. Alternatively, the active component of the planar motor can have a pole pair width that corresponds substantially to a whole-number multiple or a whole-number fraction of the pole pair width of the respective linear motor. For this purpose, coils in the active component of the planar motor and in the linear motor can each have suitable pole widths. The coils in the linear motors can be arranged in coil rows and the coils in the active component of the planar motor can be arranged in a grid or array arrangement. As a result of the correspondingly adapted pole pair widths, the workpiece carrier is similarly controllable, i.e., steerable, on the deflecting module and the feed rail and/or the discharge rail simultaneously.

Furthermore, in the inventive goods transport system, the workpiece carrier can be provided with mechanical guiding elements spaced from the main plane of the deflecting module. The mechanical guiding elements do not contact the main plane. The guiding elements can be configured, for example, as rollers, rubber lips, sprung legs or rails.

In a further embodiment of the goods transport system, at least the linear motor, which serves as a feed rail and/or a discharge rail, comprises a plurality of parallel arranged coil rows that are able to be independently actuated. The parallel arrangement is herein related to the respective main transport direction of the feed rail and/or discharge rail. Corresponding thereto, magnet packets on the workpiece carrier can be arranged in the region of parallel edges of the workpiece carrier. With the parallel arranged coil rows, a more precise electromagnetic intervention between the respective linear motor, therefore its active components, and the workpiece carrier is thus possible. This enables an accelerated movement of the workpiece carrier on the feed rail and/or discharge rail and a more precise guidance of the workpiece carrier. Similarly, on the workpiece carrier, on reaching the deflecting module, a rotation impulse can be applied via an uneven actuation of the coil rows. In this way, a complex deflection of the workpiece carrier on the deflecting module can be implemented and/or supported.

Further, in the inventive goods transport system in a region of the deflecting module, an acquirer can be provided that is configured to acquire a position and/or an orientation of the workpiece carrier. The acquirer can be at least an electric acquirer that acquires at least one electrical variable on a coil of the active component of the planar motor, i.e., on the deflecting module. The electrical acquirer can be configured, for example, as Hall effect sensors that can be configured identically. Such electrical acquirers can be arranged in a series arrangement or in an array arrangement. The acquirer can also be an optical acquirer, for example, an optical sensor that is mounted on the active component of the planar motor or on the linear motor and is configured to acquire a position of the workpiece carrier. Optical sensors of this type can also be configured in a linear or array arrangement and can be configured to be identical. Furthermore, the acquirer can be, for example, a camera that is coupled to an image processing unit. The camera can be positioned, for example, above the planar motor. With the image processing unit, for example, a workpiece carrier and/or its associated transport goods can be identified. The operation of the inventive goods transport system can thereby be monitored and regulated in a simple manner. In particular, positions and/or orientations of workpiece carriers during operation of the goods transport system can be stored and provided as a training dataset for an artificial intelligence system, for example, a neural network. The artificial intelligence can be part of a computer program product for controlling the goods transport system that can be executed, for example, on a control unit that can be coupled to the goods transport system. The invention is based, inter alia, on the unexpected realization that the inventive goods transport system can be extended in a particularly advantageous manner via training datasets obtained during operation.

Furthermore, in the inventive goods transport system, at least three discharge rails are arranged on the deflecting module. The at least three discharge rails can be arranged substantially in any desired form on the deflecting module. The deflecting module is readily suitable to serve as a complex switch or crossing for the workpiece carrier. As a result, a workpiece carrier and thus also the associated transport good can easily reach at least three separate processing stations following the deflecting module in an automation installation in a simple manner. In particular, in a goods transport system that comprises a plurality of deflecting modules, an increased number of combinations as to which processing stations a workpiece carrier and thus a transport good can reach in a passage through the automation installation can therefore be implemented. As a consequence, a substantially parallel production of different end products in the automation installation is possible, as a result of which its productivity can be increased.

In a further embodiment of the goods transport system, the workpiece carrier can be configured in a tiltable manner and in a specifiable manner when traversing the deflecting module. For this purpose, the active components of the planar motor serving as the deflecting module are suitably controllable in order to generate suitable electromagnetic fields that cause the workpiece carrier to tilt. A tilting should be understood herein to mean a rotational movement about an axis of rotation substantially parallel to the main plane of the deflecting module. In this way, for example, an overturning of the transport goods during increased accelerations can be counteracted. Alternatively or additionally, the transport good can be tilted for its processing. The versatility of the inventive goods transport system is thereby further increased.

Furthermore, the workpiece carrier in the inventive goods transport system can have at least two pairs of magnet packets. Herein, the pairs of magnet packets are arranged in a crossing pattern. This should be understood to mean that along a circulating direction of the workpiece carrier, the magnet packets of a first pair are each arranged between the magnet packets of the second pair. The workpiece carrier can be configured substantially rectangular or square and the magnet packets can each be arranged in the region of an edge of the workpiece carrier. As a result, the workpiece carrier can be moved rapidly and precisely translationally and rotationally in a simple manner.

The objects and advantages are equally achieved in accordance with the invention by a control unit, which is configured to output control commands to at least one active component of a planar motor. The control unit includes a processor and memory and is configured for a specifiable movement of a workpiece carrier on the active component. In accordance with the invention, the control unit is configured to move the workpiece carrier in a sliding manner from a feed rail via the active component to a discharge rail. The control unit can be capable of being coupled to a goods transport system in accordance with the above-described embodiments or can be part of a corresponding goods transport system. Furthermore, the control unit can be provided with a computer program product which can be executed on the control unit. The computer program product can be configured to operate a goods transport system in accordance with the above-described embodiments. The computer program product and/or the control unit can comprise an artificial intelligence, in particular, a neural network, which can be trained via a training dataset. The training dataset can be acquired, as described above, during the ongoing operation of the goods transport system or of a goods transport system of identical construction. The features of the claimed goods transport system are transferrable to the control unit in accordance with the invention.

The objects and advantages are equally achieved in accordance with the invention by a construction kit for producing the goods transport system. The construction kit comprises at least one feed rail, a plurality of discharge rails and at least one deflecting module. The deflecting module is configured as an active component of a planar motor. In accordance with the invention, the construction kit is configured to produce the goods transport system in accordance with at least one of the above-disclosed embodiments. This includes at least a mechanical compatibility between the deflecting module, the feed rail and the discharge rails. Similarly, this can comprise an electrical compatibility between these components which are operable, for example, via a common control unit. The features of the claimed goods transport system are readily transferrable to the construction kit in accordance with the invention.

The fundamental objects and advantages are equally achieved in accordance with the invention by a simulation program product that is suitable for simulating an operational behavior of the goods transport system. For this purpose, the simulation program product has commands which, when executed on a computer, cause the simulation program product to simulate the operational behavior of the goods transport system. In accordance with the invention, the goods transport system that is to be simulated is configured in accordance with the above-disclosed embodiments. The simulation program product can comprise a digital map at least of the deflecting module and of a workpiece carrier that is moved in a specifiable manner over the deflecting module.

The simulation program product can have a physics module for simulation in which the workpiece carrier is at least partially mapped. In particular, with the physics module, an application of electromagnetic forces on the workpiece carrier can be established via a corresponding actuation of an active component of a planar motor that serves as the deflecting module. Furthermore, with the physics module, the kinematic behavior of the workpiece carrier as a result of existing speeds, rotations, translations, moments of rotational inertia, weight forces and/or torques can be established. The weight forces and/or torques can be exerted via the workpiece carrier itself and/or an associated transport good. Alternatively or additionally, the workpiece carrier can also be stored as a computation model in the physics module. The physics module is also configured to simulate settable operating conditions. This includes the actuation behavior of the active component. The simulation program product can have a data interface via which corresponding data can be specified via a user input, a data connection to a real goods transport system and/or other simulation-directed computer programs. Similarly, the simulation program product can have a data interface for an output of simulation results to a user and/or other simulation-directed computer programs. With the simulation program product, for example, a defective component in the deflecting module, in the feed rail and/or in the discharge rail can be identified. Similarly, a control strategy worked out via an artificial intelligence for the goods transport system can be tested via the simulation program product. Alternatively, a control strategy for the goods transport system can be developed on the simulation program product in accordance with the invention via a simulation that is coordinated by the artificial intelligence. This can occur, in particular, based on machine learning (ML).

The fundamental goods transport system can be described substantially completely with the actuation data, i.e., the control commands that are transmitted to the active components of the deflecting module, the feed rail and/or the discharge rail, and acquisition data for the position and/or posture of the workpiece carrier. These data items can be easily adapted to one another via “upsampling” and/or “downsampling”. The invention is based, inter alia, on the unexpected realization that these data items enable a rapidly running simulation of the fundamental goods transport system. In this way, real time-capable monitoring of the goods transport system is possible via the simulation program product, which enables a reliable and safe operation. The concept of real time-capability should be understood herein in light of the respective use, in particular, the manner of the automation system in which the goods transport system is to be used. The simulation program product can further be formed a digital twin, as described, for example, in the publication US 2017/286582 A1, which is incorporated by reference herein in its entirety. The simulation program product can be configured in a monolithic manner, i.e., it can be executed completely on one hardware platform. Alternatively or additionally, the simulation program product can also be formed in a modular manner and can comprise a plurality of subprograms that can be executed on separate hardware platforms and cooperate via a communicative data connection. Such a communicative data connection can be a network connection, an internet connection and/or a mobile radio connection. The individual features of the inventive goods transport system are readily transferrable to the simulation program product.

Similarly, the fundamental objects and advantages are achieved in accordance with the invention by a method for simulating the operational behavior of the goods transport system. The method comprises a first step in which a dataset is provided via which a functioning of the goods transport system can at least be partially simulated by the method. The method further comprises a second step in which at least one operating parameter is specified via which the operating behavior to be simulated is described. The at least one operating parameter can be, for example, a specification of the number of workpiece carriers used on the goods transport system, their loading, their start position, their target position, an actuation of the feed rail and/or of the discharge rail, a summary of transport tasks to be fulfilled and/or an operating specification of the goods transport system, for example, a speed limitation for the workpiece carriers. The method further comprises a third step in which a simulation program product is executed that is configured to simulate the operating behavior of the goods transport system. The simulation of the operating behavior occurs based the dataset from the first step and the at least one operating behavior from the second step. With the simulation program product, at least one performance parameter is established, for example, a duration for fulfilling at least one transport task or an energy requirement therefor. In accordance with the invention, the goods transport system the operating behavior of which is to be simulated with the inventive method is configured in accordance with the disclosed embodiments. The features of the simulation program product outlined above are optionally transferrable to the inventive method. In particular, the fundamental objects and advantages are achieved with a simulation program product which is configured to implement the method in accordance with the disclosed embodiments.

The objects and advantages are equally achieved in accordance with the invention by use of an active component of a planar motor in the goods transport system. The goods transport system has linear motors that serve as at least one feed rail and one discharge rail. In accordance with the invention, the active component is used as a switch or a crossing for workpiece carriers between the feed rail and the discharge rail. The goods transport system can therein be configured in accordance with the disclosed embodiments. The features of the inventive goods transport system are therefore readily transferrable to the use of the active component.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be described in greater detail by reference to individual exemplary embodiments in figures. The figures are to be considered as mutually complementary to the extent that the same reference signs in the different figures have the same technical meaning. The features of the individual embodiments are also capable of being combined with one another. Furthermore, the embodiments shown in the figures are capable of being combined with the features outlined above, in which:

FIG. 1 is a schematic plan view illustration of an embodiment of the inventive transport system; and

FIG. 2 is a schematic illustration of an embodiment of a workpiece carrier.

### DETAILED DESCRIPTION OF THE EXEMPLARY EMBODIMENTS

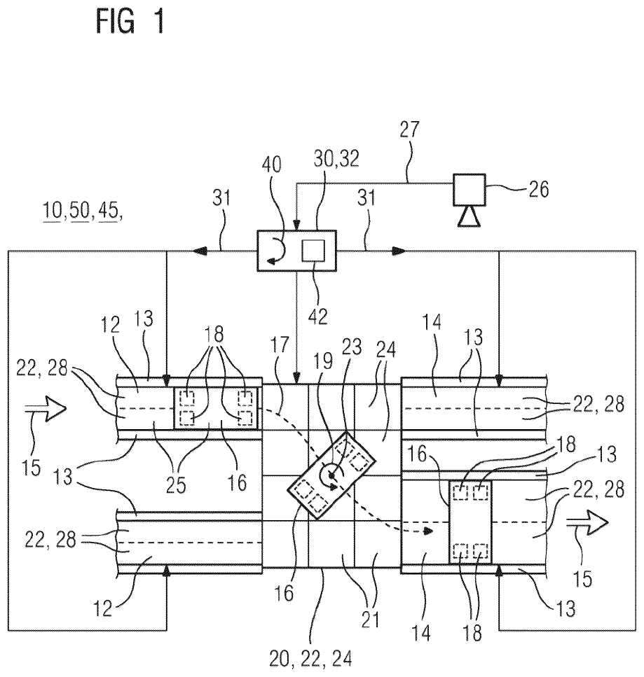

FIG. 1 schematically shows a plan view of a first embodiment of the inventive goods transport system 10. The goods transport system 10 comprises feed rails 12, over which workpiece carriers 16 can be moved linearly in a specifiable manner. The goods transport system 10 also comprises discharge rails 14, over which the workpiece carriers 16 can also be moved linearly in a specifiable manner. Arranged between the feed rails 12 and the discharge rails 14 is a deflecting module 20 that a workpiece carrier 16 crosses in order to pass from one of the feed rails 12 to one of the discharge rails 14. The feed rails 12 and the discharge rails 14 are each configured as active components 22 of a linear motor 25. The active components 22 are configured as coil rows 28 that are configurable to be actuated separately. The workpiece carrier 16 is provided with a plurality of magnet packets 18 and thereby forms a passive component. If the workpiece carrier 16 is situated on the feed rail 12, then the coil rows 18 and the workpiece carrier 16 form the linear motor 25. Correspondingly, the coil rows 28 on the discharge rails 14 that can be separately actuated also form active components 22 for a linear motor 25. If the workpiece carrier 22 is situated on the discharge rails 14, then a linear motor 25 is formed thereby. The feed rails 12 and the discharge rails 14 are each provided with mechanical guiding elements 13 that support a guidance of workpiece carriers 16.

The deflecting module 20 is configured as an active component 22 that comprises a plurality of coils 21. With the deflecting module 20, a planar motor 24 is formed if the workpiece carrier 16 is situated over the deflecting module 20. The workpiece carrier 16 forms, as a passive component, the functional counterpart to the deflecting module 20 that is configured as an active component 22. The coils 21 of the deflecting module 20 can be actuated separately. As a consequence, it is possible to act upon the magnet packets 18 on the workpiece carrier 16 in a specifiable manner. The workpiece carrier 16 that leaves the feed rail 12 is actuated by the deflecting module 20 such that it is moved substantially transversely to the main transport direction 15. Similarly, via the deflecting module 20, a rotation 19 about a rotation axis 23 is imposed upon the workpiece carrier 16. The rotation axis 23 is arranged substantially perpendicularly to the main plane of the deflecting module 20, i.e., perpendicularly to the drawing plane of FIG. 1. The workpiece carrier 16 is merged in by the deflecting module 20 with a changed orientation into the discharge rail 14 shown in FIG. 1 below. The workpiece carrier 16 herein follows a substantially S-shaped path 17. On reaching the feed rail 14 shown below in FIG. 1, the workpiece carrier 16 is moved substantially along its main transport direction 15. The deflecting module 20 serves in the goods transport system 10 as a switch or as a crossing for the workpiece carrier 16.

The goods transport system 10 also comprises a control unit 30 that is connected to the feed rails 12, the discharge rails 14 and the deflecting module 20. The coil row 28 and the coils 21 of the feed rails 12, the discharge rails 14 and/or of the deflecting module 20 can be actuated separately via control commands 31 from the control unit 30. In this way, the workpiece carrier 16 is substantially movable in any desired direction on the deflecting module 20 in a specifiable manner. For this purpose, the control unit 30 is equipped with a computer program product 40 via which the control commands 31 can be specified. The control unit 30 is also coupled to an acquirer 26, which is arranged in the region of the deflecting module 20. The acquirer 26 is configured as a camera via which a position and an orientation of the workpiece carrier 16 can be acquired. Position data 27 acquired via the acquirer 26 can be passed on to the control unit 40 for further evaluation. The computer program product 40 together with the acquirer 26 can form a regulating system and/or can monitor the operation of the goods transport system 10. Apart from positions of the workpiece carrier 16, the position data 27 can also comprise its orientations. The computer program product 40 is equipped with an artificial intelligence 42 that is configured as a neural network. The position data 27 is prepared, together with the associated control commands 31 as training datasets. On the basis thereof, the artificial intelligence 42 can be further trained. Based on an artificial intelligence 42, further trained in this way, new control strategies for the goods transport system 10 can be developed. Furthermore, the goods transport system 10 of FIG. 1 is mapped in a simulation program product 60 (not shown in detail), which is configured as a digital twin. The simulation program product 60 is configured to monitor the operation of the goods transport system 10. Alternatively or additionally, the simulation program product 60 is suitable for simulating the operating behavior of the goods transport system 10. In cooperation with the artificial intelligence 42, via simulation, control strategies for the goods transport system 10 can thereby be autonomously developed. The goods transport system 10 is produced from a construction kit 45 that comprises the deflecting module 20, the feed rails 12 and the discharge rails 14.

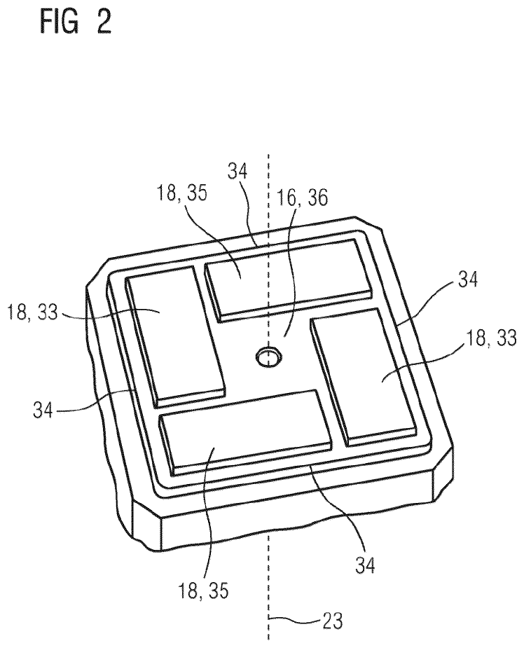

Shown schematically in FIG. 2 is lower view of an embodiment of a workpiece carrier 16 (in a view from beneath). The workpiece carrier 16 is configured substantially square and is provided on its underside with a plurality of magnet packets 18. The arrangement of the magnet packets 18 represents a passive component 26 for a linear motor 25 and/or a planar motor 24 as shown, for example, in FIG. 1. Positioned on the workpiece carrier 16, in the region of its edges 36, are the magnet packets 18, which are configured substantially rectangular. Magnet packets 18 on opposite edges 34 form a first magnet packet pair 33 and a second magnet packet pair 35. The first and second magnet packet pair 33, 35 are accordingly arranged in a crossing pattern. The arrangement of the magnet packet pairs 33, 35 permits the workpiece carrier 16 to rotate about a rotation axis 23 in a specifiable manner.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements that perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form embodiment as a general matter of design choice. It is the intention, therefore, to be limited only as indicated by the scope of the claims appended hereto.

1.-16. (canceled)

17. A goods transport system, comprising:
a feed rail;
a discharge rail, the feed and discharge rails each being configured as a linear motor and being configured to linearly move a workpiece carrier; and
a deflecting module arranged between the feed rail and the discharge rail, the deflecting module being configured to move the workpiece carrier in a specifiable manner, and the workpiece carrier being rotatable about a rotation axis perpendicular to a main plane of the deflecting module in a further specifiable manner;
wherein the deflecting module is formed as an active component of a planar motor; and
wherein at least one of the feed rail and the discharge rail are each provided with mechanical guiding elements which support a guidance of the workpiece carrier.

18. The goods transport system as claimed in claim 17, wherein the linear motor is configured to exclusively linearly move the workpiece carrier.

19. The goods transport system as claimed in claim 17, wherein the deflecting module is configured, at least in a central region, free from mechanical guiding elements.

20. The goods transport system as claimed in claim 17, wherein the deflecting module is configured, at least in a central region, free from mechanical guiding elements.

21. The goods transport system as claimed in claim 17, wherein the workpiece carrier is formed with at least one passive component of a planar motor.

22. The goods transport system as claimed in claim 17, wherein the feed rail and the discharge rail are arranged offset from one another with respect to their transport main axes.

23. The goods transport system as claimed in claim 17, wherein the active component of the planar motor includes a pole pair width which corresponds substantially to one of (i) a pole pair width of a linear motor and (ii) a whole number multiple or a whole number fraction of the pole pair width of the linear motor.

24. The goods transport system as claimed in claim 17, wherein the workpiece carrier is provided with mechanical guiding elements spaced apart from a main plane of the deflecting module.

25. The goods transport system as claimed in claim 17, wherein at least one of (i) the linear motor of the feed rail and (ii) the discharge rail comprises a plurality of parallel arranged coil rows which are able independently actuatable.

26. The goods transport system as claimed in claim 17, further comprising:
at least one acquirer arranged in a region of the deflecting module for acquiring at least one of (i) a position and (ii) an orientation of the workpiece carrier.

27. The goods transport system as claimed in claim 17, further comprising:
at least three discharge rails arranged on the deflecting module.

28. The goods transport system as claimed in claim 17, wherein the workpiece carrier is tiltable in a specifiable manner when traversing the deflecting module.

29. The goods transport system as claimed in claim 17, wherein the workpiece carrier includes at least two pairs of magnet packets which are arranged in a crossing pattern.

30. A control unit for outputting control commands to at least one active component of a planar motor, the control unit being configured to specify movement of a workpiece carrier and to move the workpiece carrier in a sliding manner from a feed rail via the active component to a discharge rail, wherein the control unit is configured to operate the goods transport system as claimed in claim 17.

31. A construction kit for producing a goods transport system, comprising:
at least one feed rail;
a plurality of discharge rails; and
at least one deflecting module which is configured as an active component of a planar motor;
wherein the construction kit is configured to produce the goods transport system as claimed in claim 17.

32. A simulation program product for simulating an operating behavior of a goods transport system, said simulation program product having a digital map of the goods transport system, wherein the goods transport system is configured as claimed in claim 17.

33. The goods transport system as claimed in claim 17, further comprising:
linear motors forming at least one feed rail and one discharge rail;
wherein the active component is utilized as at least one of a switch and a crossing for workpiece carriers between the feed rail and the discharge rail.
